(19) United States
(12) Patent Application Publication
(10) Pub. No.: US 2021/0232950 A1
(43) Pub. Date: Jul. 29, 2021

(54) INFORMATION PROCESSING SYSTEM AND METHOD FOR CONTROLLING INFORMATION PROCESSING SYSTEM

(71) Applicant: HITACHI, LTD., Tokyo (JP)

(72) Inventor: Yasutaka KONO, Tokyo (JP)

(21) Appl. No.: 17/066,522

(22) Filed: Oct. 9, 2020

(30) Foreign Application Priority Data
Jan. 24, 2020 (JP) 2020-010366

(51) Int. Cl. G06N 5/04; G06K 9/62; G06N 20/20; G06F 8/65

(52) U.S. Cl. CPC G06N 5/04; G06F 8/65; G06N 20/20; G06K 9/6264

(57) ABSTRACT

An information processing system includes performing inference by inputting data to one or more inference models, evaluating inference accuracy of inference units, generating a new inference model by training data input to a first inference unit when degradation of the inference accuracy is detected in the first inference unit, determining a factor of the degradation of the inference accuracy, and determining whether or not the new inference model is applied to a second inference unit other than the first inference unit on the basis that the determined factor is a change of an effective feature amount of the inference model or the trend change of the data input to the first inference unit.

### CROSS-REFERENCE TO RELATED APPLICATION

This application claims priority pursuant to 35 U.S.C. § 119 from Japanese Patent Application No. 2020-010366, filed on Jan. 24, 2020, the entire disclosure of which is incorporated herein by reference.

### BACKGROUND

### Technical Field

The present invention relates to an information processing system and a method for controlling the information processing system, and particularly, to a technology for performing inference by utilizing machine learning.

### Related Art

In recent years, in various fields such as a retail industry and a manufacturing industry, an information processing system for performing inference by utilizing machine learning has been introduced. In such an information processing system, it is required to continuously maintain inference accuracy throughout actual operation. U.S. Patent Application Publication No. 2019/0156247 discloses a technique of evaluating accuracy for inference results performed by each of a plurality of machine learning models and selecting a machine learning model on the basis of the evaluation.

### SUMMARY

In an information processing system utilizing machine learning, when degradation of inference accuracy is detected in a certain inference environment, improvement of the inference accuracy may be expected by performing retraining by using data acquired as an inference target (hereinafter, referred to as “inference data”) as the training target data (hereinafter, referred to as “training data”). In addition, improvement of the inference accuracy or processing efficiency may be expected by sharing a retrained machine learning model (hereinafter, referred to as “inference model”) also in other inference environments. However, for example, because a cause of the accuracy degradation is a trend change of the inference data unique to a certain inference environment, the inference accuracy in other inference environments may degrade adversely if the inference model obtained by retraining the inference data acquired in this inference environment as the training data is applied to other inference environments

The technique disclosed in U.S. Patent Application Publication No. 2019/0156247 is premised on that the inference data does not have a trend change unique to a particular inference environment as in the natural language processing or image recognition. For this reason, it is difficult to apply the technique to a use case in which the trend of the inference data is different for each inference environment, for example, in a case where future sales are forecasted by using an inference environment prepared for each store with sales data transmitted from a plurality of stores as the inference data, or the like.

Under the background described above, the present invention provides an information processing system and a method for controlling the information processing system, capable of securing the inference accuracy in each inference environment for a machine learning system that performs inference using a plurality of inference environments.

An aspect of the present invention to achieve the above objective is an information processing system comprising: a plurality of inference units that perform inference by inputting data to one or more inference models; an inference accuracy evaluation unit that evaluates inference accuracy of the inference units; a training unit that generates a new inference model by training data input to a first inference unit when degradation of the inference accuracy is detected in the first inference unit; a factor determination unit that determines a factor of the degradation of the inference accuracy; and a deployment determination unit that determines whether or not the new inference model is applied to a second inference unit other than the first inference unit on the basis of the determined factor.

Other problems and solutions thereof disclosed in the present application will become more apparent by reading description of the embodiments of the present invention and the accompanying drawings.

According to the present invention, it is possible to secure the inference accuracy under each inference environment in a machine learning system that performs inference using a plurality of inference environments.

### BRIEF DESCRIPTION OF THE DRAWINGS

FIG. 1 illustrates an exemplary information processing system utilizing machine learning;

FIG. 2 is a diagram illustrating a mechanism of the information processing system according to an embodiment of the present invention;

FIG. 3 is a diagram illustrating a schematic configuration of the information processing system according to an embodiment of the present invention;

FIG. 4 is a diagram illustrating an exemplary information processing apparatus;

FIG. 5 is a diagram illustrating main functions provided in an inference server;

FIG. 6 illustrates an exemplary inference model allocation table;

FIG. 7 is a diagram illustrating main functions provided in a training server;

FIG. 8 is a diagram illustrating main functions provided in a management server;

FIG. 9 illustrates an exemplary data trend management table;

FIG. 10 illustrates an exemplary inference accuracy management table;

FIG. 11 illustrates an exemplary ML code management table;

FIG. 12 illustrates an exemplary inference model deployment management table;

FIG. 13 is a flowchart illustrating an inference processing;

FIG. 14 is a flowchart illustrating a data trend determination processing;

FIG. 15 is a flowchart illustrating an inference accuracy evaluation processing;

FIG. 16 is a flowchart illustrating an accuracy degradation countermeasure determination processing;

FIG. 17 is a flowchart illustrating a ML code deployment processing;

FIG. 18 is a diagram schematically illustrating an exemplary accuracy degradation countermeasure determination processing; and

FIG. 19 is a diagram schematically illustrating an exemplary accuracy degradation countermeasure determination processing.

### DETAILED DESCRIPTION OF EMBODIMENTS

Hereinafter, embodiments of the present invention will be described with reference to the accompanying drawings. In the following description, like or similar reference numerals denote like or similar elements, and they will not be described for simplicity purposes. In addition, subscripts such as alphabets may be attached to a common reference symbol to distinguish configurations of the same type. In addition, in the following description, the letters “S” preceding the reference numerals denote processing steps. In the following description, machine learning may be referred to as “ML”. Furthermore, in the following description, the “machine learning model” is also referred to as “inference model”.

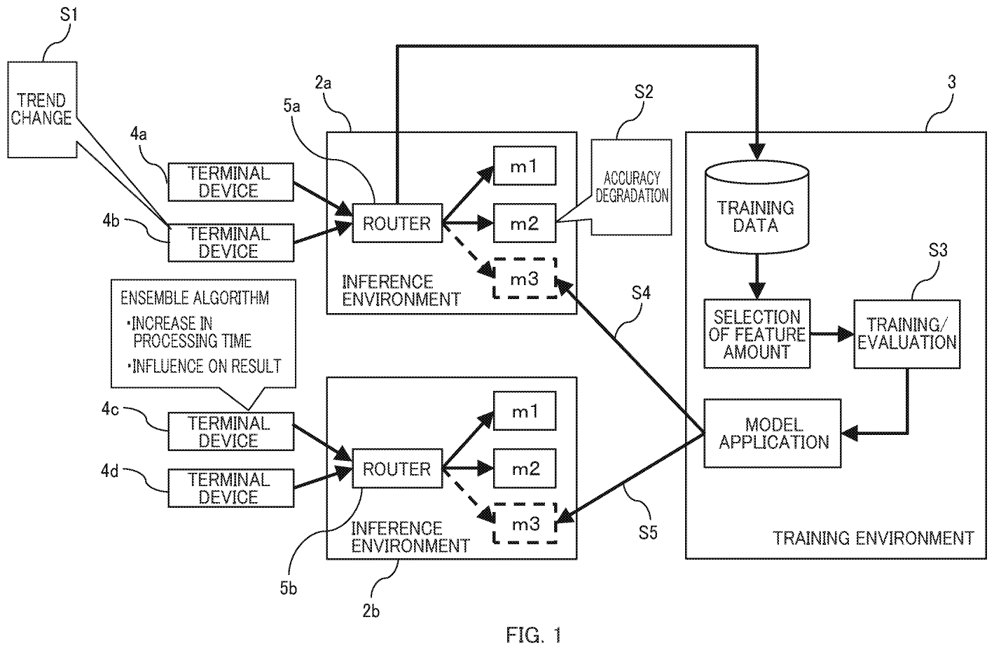

FIG. 1 is a diagram illustrating an exemplary information processing system utilizing machine learning. The illustrated information processing system includes a plurality of inference environments 2a and 2b and a training environment 3 in which inference models m1 to m3 used for inference of each inference environment 2a and 2b are updated. The illustrated information processing system predicts, for example, a sales quantity, a purchase quantity, a stock quantity, and the like at each store on the basis of data transmitted from terminal devices 4a to 4d provided in each of a plurality of stores (hereinafter, referred to as “inference data”).

As illustrated in FIG. 1, the inference data transmitted from the terminal devices 4a and 4b are input to a router 5a of the inference environment 2a, and the inference data transmitted from the terminal devices 4c and 4d are input to a router 5b of the inference environment 2b.

The router 5a performs inference by allocating inference data to at least one of the inference models m1 and m2 applied to the inference environment 2a. In addition, the router 5b performs inference by allocating inference data to at least one of the inference models m1 and m2 applied to the inference environment 2b. Note that the routers 5a and 5b are not essential, and the machine learning models may also be fixedly allocated to the terminal devices 4a and 4b.

In the illustrated information processing system, for example, it is assumed that a trend of the inference data transmitted from the terminal device 4b changes (S1), and accordingly, inference accuracy degradation is detected in the inference performed by the inference model m2 (S2). In this case, for example, retraining is performed using the inference data as the training data in the training environment 3 (S3), and a new inference model m3 generated from the retraining is applied to the inference environment 2a (S4). In addition, when the same inference model m3 is also used in the inference environment 2b, the new inference model m3 is also applied to the inference environment 2b (S5).

Here, in this manner, if it is detected that the inference accuracy is degraded in a certain inference environment (S2), and the new inference model m3 retrained thereby is also applied to other inference environments, the following problems may occur. That is, in the aforementioned example, if the trend of the inference data changes only in the terminal device 4b that uses the inference environment 2a, and the trend of the inference data transmitted from the terminal devices 4c and 4b that use the inference environment 2b does not change, the inference accuracy in the inference environment 2b may degrade adversely in some cases by applying the new inference model m3 to the inference environment 2b. In addition, when the new inference model m3 is used, for example, in a so-called ensemble algorithm (ensemble model) that obtains the best result by using each inference result of a plurality of inference models, there is a possibility of degrading the inference accuracy, and calculation resources or time required for the inference may be consumed wastefully by applying the new inference model m3 to the inference environment 2b.

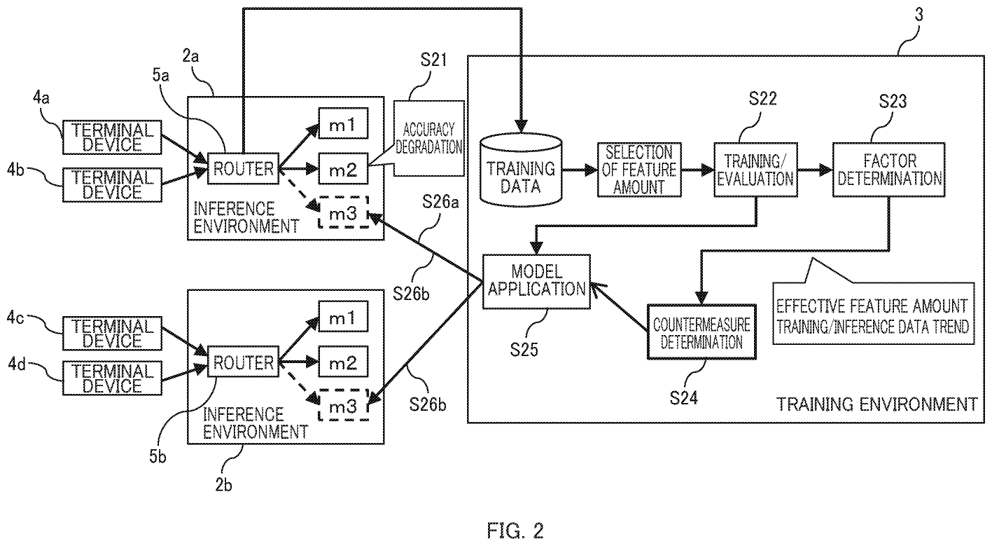

In this regard, as illustrated in FIG. 2, in the information processing system according to this embodiment, for example, when degradation of the inference accuracy is detected in the inference model m2, and retraining is performed to secure accuracy (S21, S22), a factor of the inference accuracy degradation is determined (S23), an application method for the new inference model m3 is determined depending on the determined factor (S24), and the aforementioned method for determining the generated new inference model m3 is applied to the inference environments 2a and 2b (S25). Specifically, for example, if the determined factor is a trend change of the inference data, the information processing system applies the generated new inference model m3 only to the inference environment 2a (S26a). Otherwise, if the determined factor is the change of an effective feature amount, the new inference model m3 is applied to both the inference environments 2a and 2b (S26b). Note that the effective feature amount described above is a feature amount effective for obtaining a correct inference result.

In such a mechanism, the trained new inference model m3 is applied only to the inference environment 2 by which improvement of the inference accuracy may be expected, and it is possible to prevent degradation of the inference accuracy caused by applying the new inference model m3 to the inference environment 2 by which improvement of the inference accuracy may not be expected. In addition, it is possible to prevent the inference processing from being performed unnecessarily and prevent computational resources or time required for the inference from being consumed wastefully.

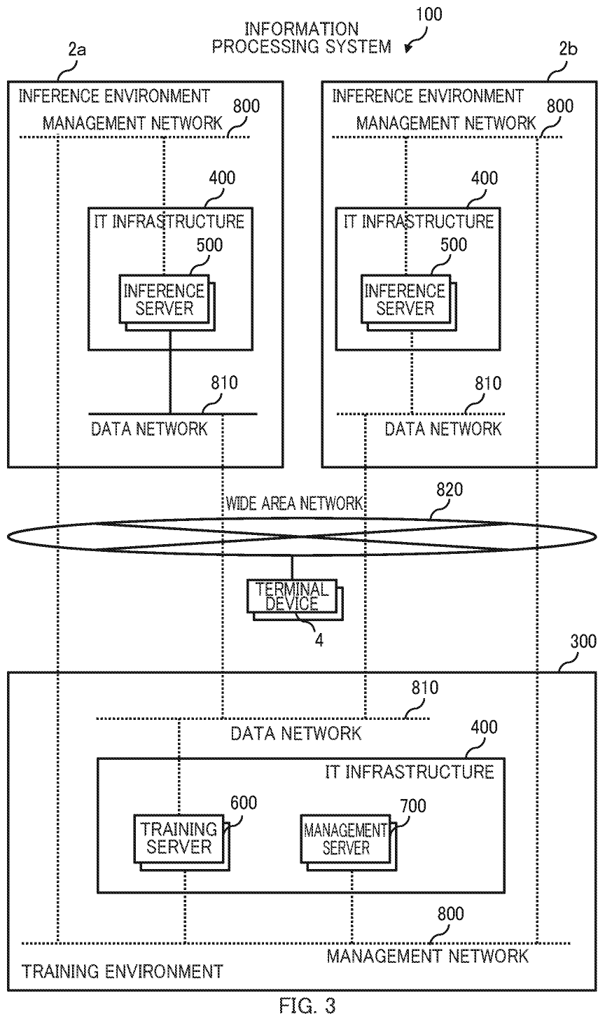

FIG. 3 illustrates a schematic configuration of the information processing system 100 according to an embodiment of the present invention. The information processing system 100 includes an inference server 500 that exists in each of the two inference environments 2a and 2b, a training server 600, a management server 700 that exist in the training environment 3, and a terminal device 4 that transmits inference data to the inference server 500. All of the inference server 500, the training server 600, the management server 700, and the terminal device 4 are configured using information processing apparatuses (computer). Each of the inference environments 2a and 2b and the training environment 3 may exist in geographically different places. The arrangement of the inference server 500, the training server 600, and the management server 700 are not necessarily limited to those illustrated in the drawings, and the numbers thereof are also not necessarily limited.

The terminal device 4 transmits, for example, actual record values such as sales data as the inference data to the inference server 500. Note that the terminal device 4 transmits the inference data to the inference server 500, for example, along with an inference execution request (inference request). When the inference server 500 receives the inference data, the received inference data is input to the inference model allocated to this inference data (the terminal device 4 as a transmission source of the inference data) to perform an inference processing such as future sales prediction. When degradation of the inference accuracy is detected, the training server 600 generates a new inference model by training the inference data input to the inference model having the degraded inference accuracy. The management server 700 determines an application method (countermeasure method) for the new inference model depending on the factor of the inference accuracy degradation, and applies the new inference model to the inference environment 2 using the determined method.

The inference environment 2a includes an IT infrastructure 400 that provides an inference server 500, a management network 800, and a data network 810. The inference server 500 existing in each of the inference environments 2a and 2b is communicatably connected via the data network 810. The training environment 3 includes an IT infrastructure 400 that realizes the training server 600 and the management server 700, a management network 800, and a data network 810. The inference server 500, the training server 600, and the management server 700 are communicatably connected via the management network 800. In addition, the inference server 500 and the training server 600 are communicatably connected via the data network 810. The management network 800 is usually used for management of the inference server 500 or the training server 600. The data network 810 is usually used for communication performed between the inference server 500 and the training server 600 when a service is actually provided to the terminal device 4 (in actual performance). The terminal device 4 is communicatably connected to the inference server 500 via the wide area network 820 or the data network 810.

The communication network (management network 800, data network 810, and wide area network 820) consists of, for example, communication infrastructures such as WAN (Wide Area Network), LAN (Local Area Network), the Internet, leased lines, and public communication networks. The configuration of the communication network illustrated in FIG. 3 is exemplary, and may be appropriately configured from the viewpoints of necessity on maintenance or operation, user's needs, security, and the like. For example, the management network 800 and the data network 810 may belong to the same communication network. In addition, for example, a communication network that connects the terminal device 4 and the inference server 500 may be provided separately from the data network 810.

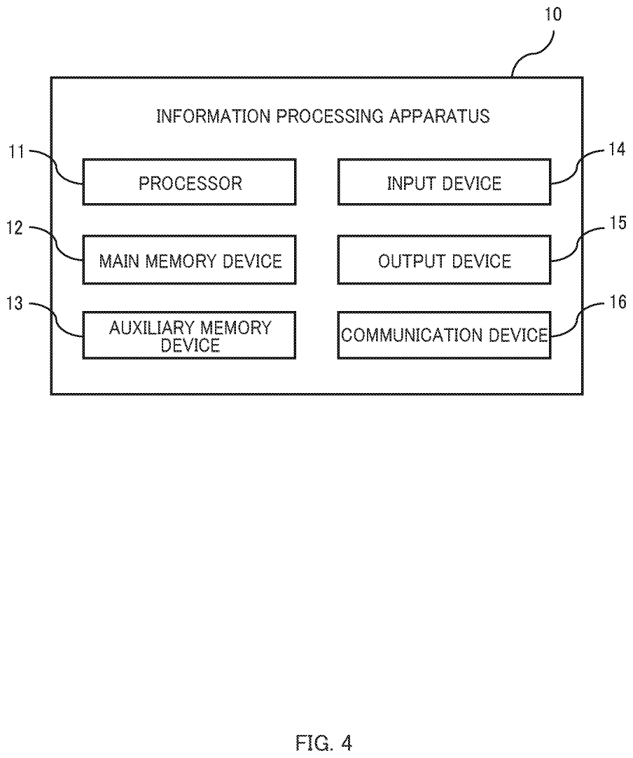

FIG. 4 illustrates an exemplary information processing apparatus (computer) that can be used to configure each of the inference server 500, the training server 600, the management server 700, and the terminal device 4. As illustrated in FIG. 4, the illustrated information processing apparatus 10 includes a processor 11, a main memory device 12, an auxiliary memory device 13, an input device 14, an output device 15, and a communication device 16. These are communicatably connected via a communication means such as a bus (not shown). Note that each of the inference server 500, the training server 600, the management server 700, and the terminal device 4 may have a minimum configuration necessary for realizing the functions provided by each one of them, and it is not necessary to have all of the components of the illustrated information processing apparatus 10.

The information processing apparatus 10 includes, for example, a desktop personal computer, an office computer, a mainframe, a mobile communication terminal (such as a smart phone, a tablet, a wearable terminal, and a notebook personal computer), or the like. The information processing apparatus 10 may be realized by using virtual information processing resources provided on the basis of a virtualization technology, a process space separation technology, or the like, as in a virtual server provided by a cloud system. In addition, all or a part of the functions of the inference server 500, the training server 600, the management server 700, and the terminal device 4 may be realized, for example, by a service provided by a cloud system using an API (Application Programming Interface) or the like.

The processor 11 is configured of, for example, a CPU (Central Processing Unit), an MPU (Micro Processing Unit), a GPU (Graphics Processing Unit), an AI (Artificial Intelligence) chip, an FPGA (Field Programmable Gate Array), an ASIC (Application Specific Integrated Circuit), or the like.

The main memory device 12 is a device that stores programs or data, and is configured of, for example, a ROM (Read Only Memory), a RAM (Random Access Memory), a non-volatile memory (NVRAM (Non Volatile RAM)), or the like. The auxiliary memory device 13 includes, for example, an SSD (Solid State Drive), a hard disk drive, an optical memory device (such as CD (Compact Disc) or DVD (Digital Versatile Disc)), a storage system, a read/write device for a recording medium such as an IC card, an SD card, or an optical recording medium, a memory area of a virtual server, or the like. Programs or data may be read into the auxiliary memory device 13 using the recording medium reader device or the communication device 16. The programs or data stored (memorized) in the auxiliary memory device 13 are read into the main memory device 12 from time to time.

The input device 14 is an interface that receives an input from the outside, and includes, for example, a keyboard, a mouse, a touch panel, a card reader, a voice input device, or the like. The output device 15 is an interface that outputs various types of information such as a processing progress and a processing result. The output device 15 includes, for example, a display device (such as a liquid crystal monitor, an LCD (Liquid Crystal Display), and a graphic card) that visualizes various types of information described above, a device that converts various types of information described above into speech (such as a voice output device (speaker)), or a device that converts various types of information described above into characters (such as printer). The output device 15 constitutes a user interface along with the input device 14. Note that, for example, the information processing apparatus 10 may be configured to input or output information to/from other devices (such as a smart phone, a tablet, a notebook computer, or various types portable information terminals) via the communication device 16.

The communication device 16 realizes communication with other devices. The communication device 16 is a wireless or wired communication interface that realizes communication with other devices via a communication network (including at least any one of the management network 800, the data network 810, and the wide area network 8200), and includes, for example, a NIC (Network Interface Card), a radio communication module, a USB (Universal Serial Bus) module, a serial communication module, or the like. Subsequently, the functions of each device will be described.

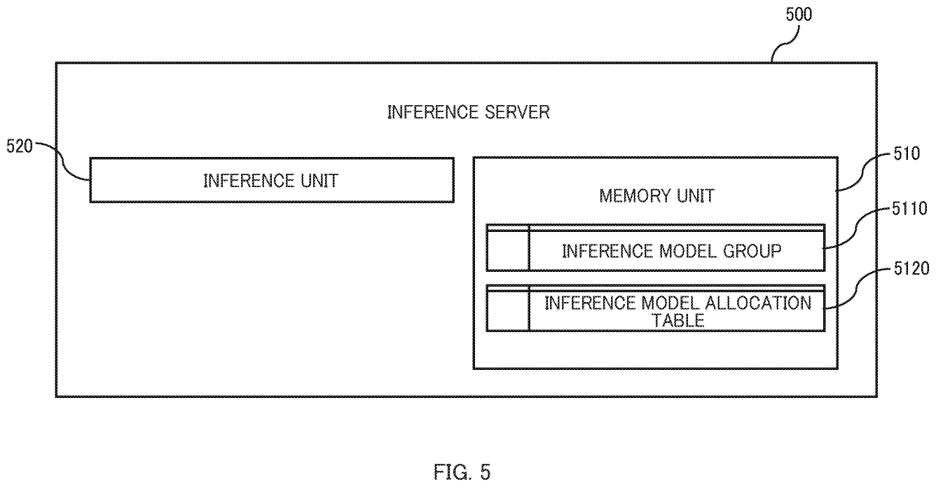

FIG. 5 illustrates main functions provided in the inference server 500. As illustrated in FIG. 5, the inference server 500 includes a memory unit 510 and an inference unit 520. Such functions are realized by the processor 11 of the information processing apparatus 10 of the inference server 500 that reads and executes the program stored in the main memory device 12 of the information processing apparatus 10 or by hardware of the information processing apparatus 10 (such as a FPGA, ASIC, or AI chip).

The memory unit 510 functions as a repository that stores and manages the inference model group 5110 and the inference model allocation table 5120. The memory unit 510 stores these data, for example, as a database table provided by a DBMS or a file provided by a file system.

The inference model group 5110 includes one or more inference models generated by a machine learning algorithm or training data. The inference model includes, for example, a model that predicts a future value of time series data using a regression equation, a model that classifies images using DNN (Deep Neural Network), or the like.

The inference model allocation table 5120 includes information on allocation of the inference data transmitted from the terminal device 4 to the inference model.

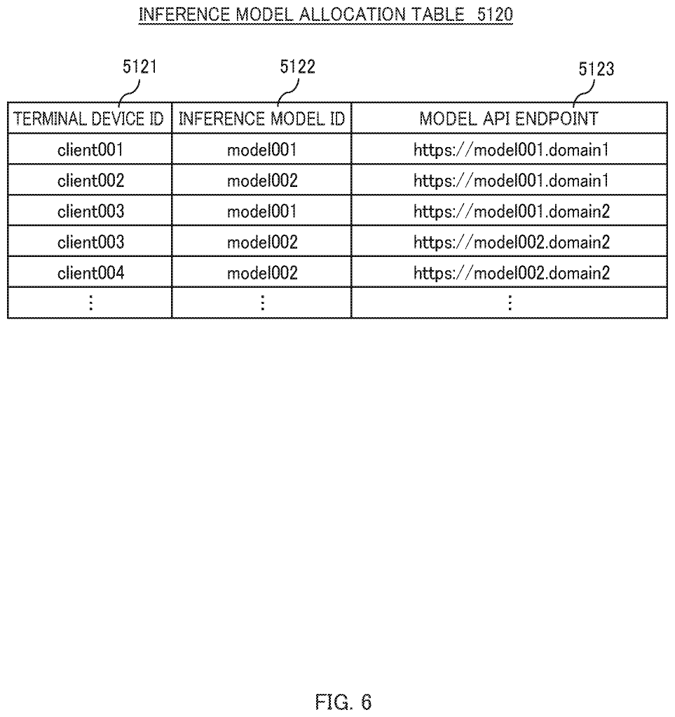

FIG. 6 illustrates an exemplary inference model allocation table 5120. The illustrated inference model allocation table 5120 includes a plurality of records (entries) having respective items of a terminal device ID 5121, an inference model ID 5122, and an inference model API endpoint 5123. In the terminal device ID 5121, a terminal device ID as an identifier of the terminal device 4 is set. In the inference model ID 5122, an inference model ID as an inference model identifier is set. In the inference model API endpoint 5123, an API (Application Programming Interface) endpoint (for example, a network address such as a URL (Uniform Resource Locator) or an IP (Internet Protocol) address) for allowing the inference model to receive an inference request along with inference data is set. The API may be provided by the inference server 500 or by a device other than the inference server 500.

In the case of the illustrated inference model allocation table 5120, for example, the inference data transmitted from the terminal device 4 having a terminal device ID 5121 of “client001” indicates that the inference model ID 5122 is input to the inference model of “model001”. In addition, in the inference model API endpoint 5123, a URL including a description of a domain name indicating the inference environment in which the inference server 500 where the inference model is executed is installed is set. In FIG. 6, “domain1” indicates the inference environment 2a, and “domain2” indicates the inference environment 2b.

Different instances of the same inference model may be executed in a plurality of environments. For example, in the example of FIG. 6, an instance of the inference model having an inference model ID 5122 of “model1” is executed in the inference environment 2a expressed as “domain1” and the inference environment 2b expressed as “domain2”, and the API endpoint expressed as “https://model001.domain1” and the API endpoint expressed as “https://model001.domain2” receive the inference data (inference request). In addition, the inference data transmitted from the same terminal device 4 may be input to a plurality of inference models in some cases. For example, in the example of FIG. 6, the inference data from the terminal device 4 having a terminal device ID 5121 of “client003” is input to the inference model having an inference model ID 5122 of “model001” and the inference model having an inference model ID 5122 of “model002”. Note that, for example, when the inference is performed using the ensemble algorithm, the inference data transmitted from the same terminal device 4 are input to a plurality of inference models in this manner.

Note that, although the inference models to which the inference data transmitted from the terminal device 4 are input are managed by using the inference model allocation table 5120 as described above in this embodiment, they may also be managed by other methods. For example, when name resolution of the inference model that processes inference data is performed using DNS (Domain Name System), network addresses allocated to different inference models (APIs) may be returned to each terminal device 4.

Returning to FIG. 5, the inference unit 520 receives inference data from the terminal device 4 and performs the inference processing by inputting the received inference data to the inference model of the inference server 500 specified from the inference model allocation table 5120. In this manner, the inference unit 520 functions as a router that transmits the inference data to the allocation target.

Note that the method of transmitting the inference data from the terminal device 4 to the inference unit 520 is not necessarily limited. For example, the API provided by the inference unit 520 may be called from the terminal device 4. In addition, for example, the terminal device 4 may store inference data in a memory area of a storage accessible by both the terminal device 4 and the inference unit 520, and access information (such as a connection target or authentication information) to the inference data stored in the storage may be transmitted from the terminal device 4 to the inference unit 520. Then, the inference unit 520 may acquire the inference data from the storage using the access information when it receives an inference request from the terminal device 4.

The inference unit 520 and the inference model allocation table 5120 may be deployed only in any one of the inference servers 500 for each of the two inference environments 2a and 2b. In addition, the inference server 500 that stores the inference unit 520 and the inference model allocation table 5120 and the inference server 500 that stores the inference model group 5110 may be deployed in different information processing apparatuses. A relationship between the inference unit 520, the inference server 500, and the inference environment 2 is not necessarily limited. For example, the inference unit 520 may be realized by a plurality of inference servers 500. Furthermore, the inference unit 520 and the inference environment 2 may or may not correspond to each other on a one-to-one basis.

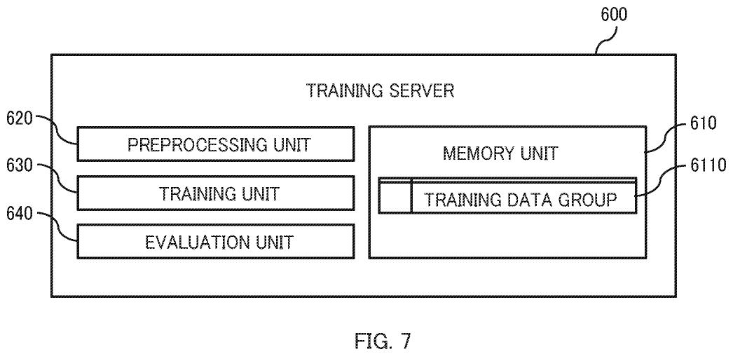

FIG. 7 illustrates main functions of the training server 600. As illustrated in FIG. 7, the training server 600 has each function of the memory unit 610, the preprocessing unit 620, the training unit 630, and the evaluation unit 640. Such functions are realized by the processor 11 of the information processing apparatus 10 of the training server 600 that reads and executes the program stored in the main memory device 12 of the information processing apparatus 10 or by hardware of the information processing apparatus 10 (such as a FPGA, ASIC, or AI chip).

The memory unit 610 functions as a repository that stores and manages the training data group 6110. The memory unit 610 stores the training data group 6110, for example, as a database table provided by DBMS or a file provided by a file system. The training data group 6110 includes data serving as a generating source of the training data (hereinafter, referred to as “generator data”) and training data generated by the preprocessing unit 620 on the basis of the generator data. The generator data is, for example, inference data acquired from the terminal device 4.

The pre-processing unit 620 performs various pre-processings on the generator data to generate training data and evaluation data. The preprocessing includes, for example, a processing for complementing a missing value of the generator data, a processing for normalizing the generator data, a processing for extracting a feature amount, a processing for dividing the generator data into training data and evaluation data, and the like.

The training unit 630 performs machine learning on the basis of the training data to generate an inference model. The algorithm for generating the inference model is not necessarily limited. For example, the algorithm includes DNN (Deep Neural Network), various regression analyses, time series analyses, ensemble learning, and the like.

The evaluation unit 640 evaluates the performance of the inference model using the evaluation data. The type of the performance of the inference model or the method of evaluating the performance of the inference model is not necessarily limited. For example, the performance type of the inference model includes accuracy, fairness, and the like. For example, the method of evaluating the inference model includes a method of using a mean square error or a mean absolute error with respect to an actual value, or a coefficient of determination as an evaluation index.

In the following description, a program or data for realizing the processing for training of the inference model (the processings of each of the preprocessing unit 620, the training unit 630, and the evaluation unit 640) will be referred to as “ML code”. The ML code is updated, for example, when the effective feature amount changes. The ML code may be activated by, for example, a person (such as a developer of the inference model), or may be automatically executed by sequentially calling the ML code using predetermined software. In addition, for example, the predetermined software may execute the ML code under various conditions (algorithm selection or parameter setting) to automatically select the inference model having the highest evaluation.

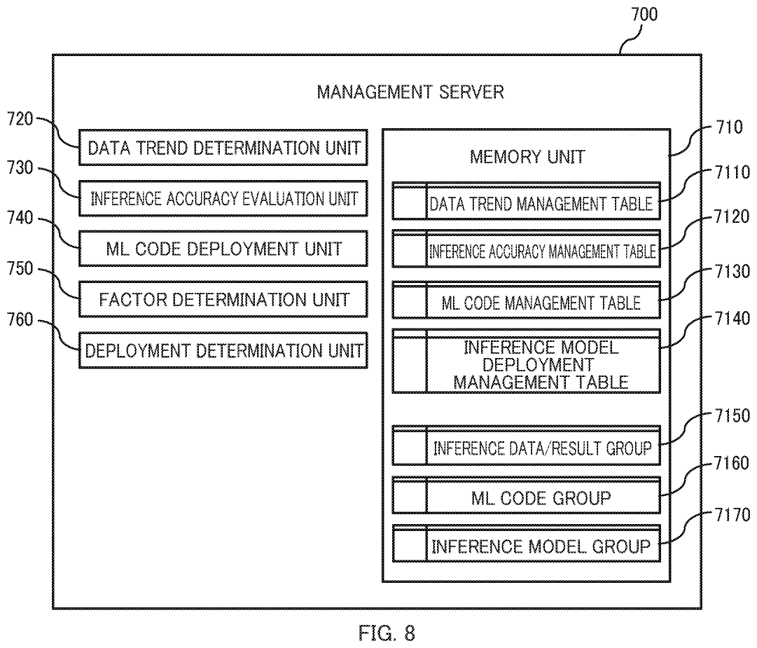

FIG. 8 illustrates main functions of the management server 700. As illustrated in FIG. 8, the management server 700 has each function of a memory unit 710, a data trend determination unit 720, an inference accuracy evaluation unit 730, an ML code deployment unit 740, a factor determination unit 750, and a deployment determination unit 760. Note that the management server 700 may further have a function of supporting development of the ML code by a person (such as a developer of the inference model). Such functions are realized by the processor 11 of the information processing apparatus 10 of the management server 700 that reads and executes the program stored in the main memory device 12 of the information processing apparatus 10 or by hardware of the information processing apparatus 10 (such as a FPGA, ASIC, or AI chip).

The memory unit 710 functions as a repository that stores and manages a data trend management table 7110, an inference accuracy management table 7120, an ML code management table 7130, an inference model deployment management table 7140, an inference data/result group 7150, an ML code group 7160, and an inference model group 7170. The memory unit 710 stores such information (data), for example, as a database table provided by DBMS or a file provided by the file system. The memory unit 710 may further store programs or data for realizing the function of managing the ML code or the inference model. For example, the memory unit 710 may store a program that displays a trend of the inference data and a temporal change of the inference accuracy.

The data trend management table 7110 includes information indicating the result of grouping the trends of the inference data transmitted from the terminal device 4 to the inference server 500.

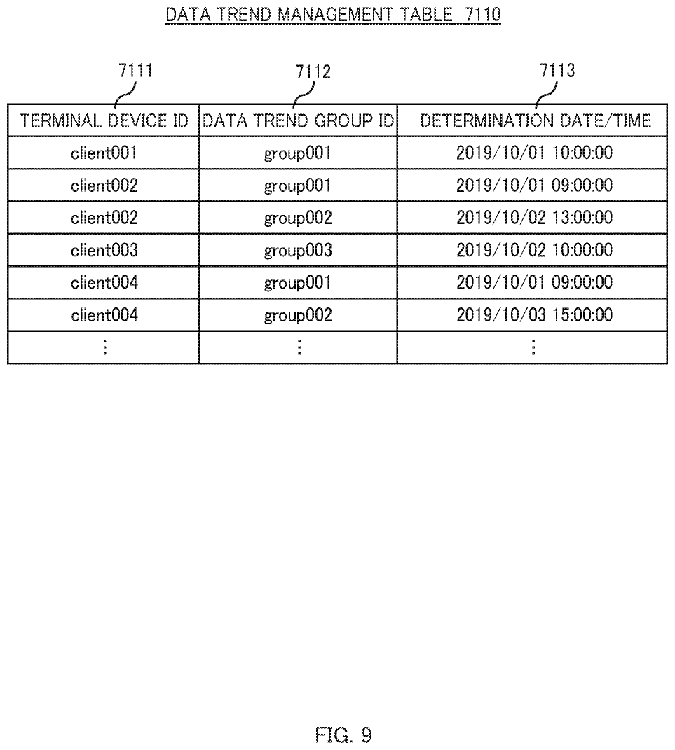

FIG. 9 illustrates an exemplary data trend management table 7110. As illustrated in FIG. 9, the data trend management table 7110 includes a plurality of records having respective items of a terminal device ID 7111, a data trend group ID 7112, and a determination date/time 7113. Among them, a terminal device ID is set in the terminal device ID 7111. A data trend group ID as an identifier assigned to each data trend group that is a group for classifying inference data having similar trends is set in the data trend group ID 7112. A date/time at which the data trend determination unit 720 determines the trend of the inference data transmitted from the terminal device 4 having the terminal device ID is set in the determination date/time 7113. In the example of FIG. 9, the trend of the inference data transmitted from the terminal device 4 having an terminal device ID 7111 of “client002” is a data trend indicated by a data trend group ID 7112 of “group001” at a determination date/time 71113 of “2019/10/01 09:00:00” and a data trend indicated by a data trend group ID 7112 of “group002” at a determination date/time 7113 of ““2019/10/02 13:00:00”. As a result, it possible to detect a change in the trend of the inference data transmitted from the terminal device 4.

Returning to FIG. 8, the inference accuracy management table 7120 manages information indicating the accuracy of the inference result (inference accuracy) obtained by inputting the inference data transmitted from the terminal device 4 into the inference model.

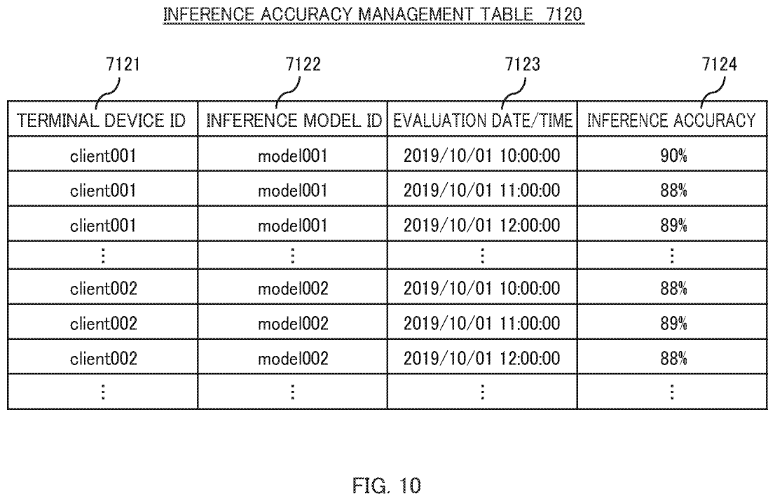

FIG. 10 illustrates an exemplary inference accuracy management table 7120. As illustrated in FIG. 10, the inference accuracy management table 7120 contains a plurality of records having respective items of a terminal device ID 7121, an inference model ID 7122, an evaluation date/time 7123, and an inference accuracy 7124. Among them, the terminal device ID is set in the terminal device ID 7121. An inference model ID is set in the inference model ID 7122. In the evaluation date/time 7123, the date/time at which the inference accuracy evaluation unit 730 infers and evaluates the inference accuracy by inputting inference data to the inference model of the inference model ID of the terminal device 4 of the terminal device ID is set. Information indicating the inference accuracy evaluated by the inference accuracy evaluation unit 730 is set in the inference accuracy 7124. In the example of FIG. 10, as a result of performing inference by inputting the inference data transmitted from the terminal device 4 having a terminal device ID 7121 of “client001” into the inference model having an inference model ID 7122 of “mode1001”, the inference accuracy 7124 is “90%” at an evaluation date/time 7123 of “2019/10/01 10:00:00”, and the inference accuracy 7124 is “88% at an evaluation date/time 7123 of “2019/10/01 11:00:00” (this means that the inference accuracy degrades).

Returning to FIG. 8, the ML code management table 7130 manages information indicating a relationship between the training server 600 and the ML code deployed on the training server 600.

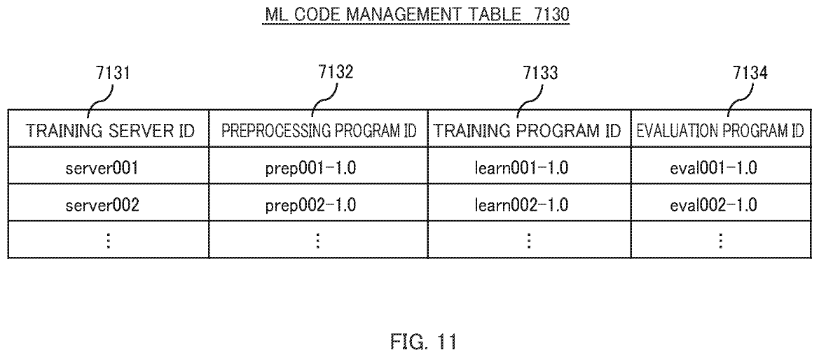

FIG. 11 illustrates an exemplary ML code management table 7130. The ML code management table 7130 contains a plurality of records having respective items of a training server ID 7131, a preprocessing program ID 7132, a training program ID 7133, and an evaluation program ID 7134. A training server ID as an identifier of the training server 600 is set in the training server ID 7131. A preprocessing program ID as an identifier of a program that realizes the preprocessing unit 620 is set in the preprocessing program ID 7132. In training program ID 7133, a training program ID as an identifier of a program that realizes training unit 630 is set. The evaluation program ID 7134 manages an evaluation program ID as an identifier of a program that realizes the evaluation unit 640. In the example of FIG. 11, for example, a program having a preprocessing program ID 7132 of “prep001-1.0”, a program having a training program ID 7133 of “learn001-1.0”, and a program having an evaluation program ID 7134 of “eval001-1.0” are deployed on the training server 600 having a training server ID 7131 of “server001”.

Returning to FIG. 8, the inference model deployment management table 7140 contains information indicating a relationship between the inference server 500, an inference model deployed on the inference server 500, and information on the inference model API endpoint that receives the inference data transmitted from the terminal device 4.

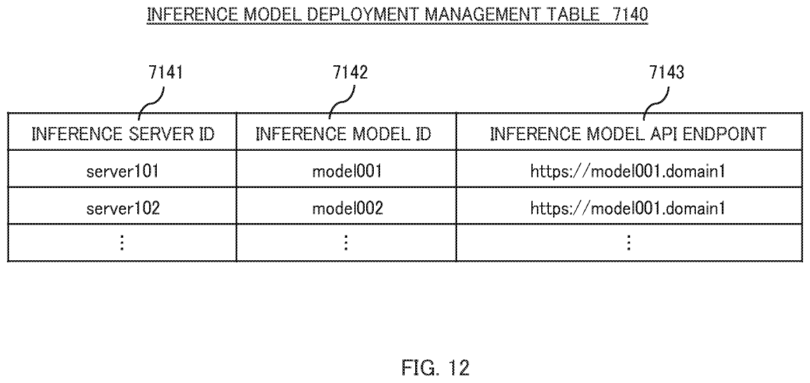

FIG. 12 illustrates an exemplary inference model deployment management table 7140. As illustrated in FIG. 12, the inference model deployment management table 7140 contains a plurality of records having respective items of an inference server ID 7141, an inference model ID 7142, and an inference model API endpoint 7143. An inference server ID as an identifier of the inference server 500 is set in the inference server ID 7141. An inference model ID is set in the inference model ID 7142. Information indicating an API endpoint for allowing the inference model to receive inference data along with an inference request is set in the inference model API endpoint 7143. The example illustrated in FIG. 12 shows that an inference model having an inference model ID 7142 of “model001” is deployed on the inference server 500 having an inference server ID 7141 of “server101”, and the inference model receives the inference request and the inference data transmitted from the terminal device 4 at the API endpoint having an inference model API endpoint 7143 of “https://model001.domain”.

Returning to FIG. 8, the inference data/result group 7150 contains inference data transmitted from the terminal device 4 to the inference server 500 and inference results transmitted from the inference server 500 to the terminal device 4. The ML code group 7160 contains ML codes. The inference model group 7170 contains information on the inference model.

The data trend determination unit 720 determines the trend of the inference data transmitted from the terminal device 4 to the inference server 500. The data trend determination unit 720 stores a result of determination for the trend of the inference data in the data trend management table 7110.

The inference accuracy evaluation unit 730 evaluates accuracy of the inference result of the inference model and detects whether or not the inference accuracy degrades. The inference accuracy evaluation unit 730 manages the evaluation result in the inference accuracy management table 7120.

The ML code deployment unit 740 deploys the ML code included in the ML code group 7160 on the training server 600. The ML code deployment unit 740 manages a relationship between the ML code and the training server 600 on which the ML code is deployed in the ML code management table 7130.

The factor determination unit 750 determines a factor that causes degradation of the inference accuracy when the inference unit 520 detects the degradation of the inference accuracy.

The deployment determination unit 760 determines deployment of the inference model stored in the inference model group 7170 on the inference server 500 or allocation of the inference model to the terminal device 4. The deployment determination unit 760 manages a deployment status of the inference model on the inference server 500 in the inference model deployment management table 7140.

Subsequently, a processing performed by the information processing system 100 will be described.

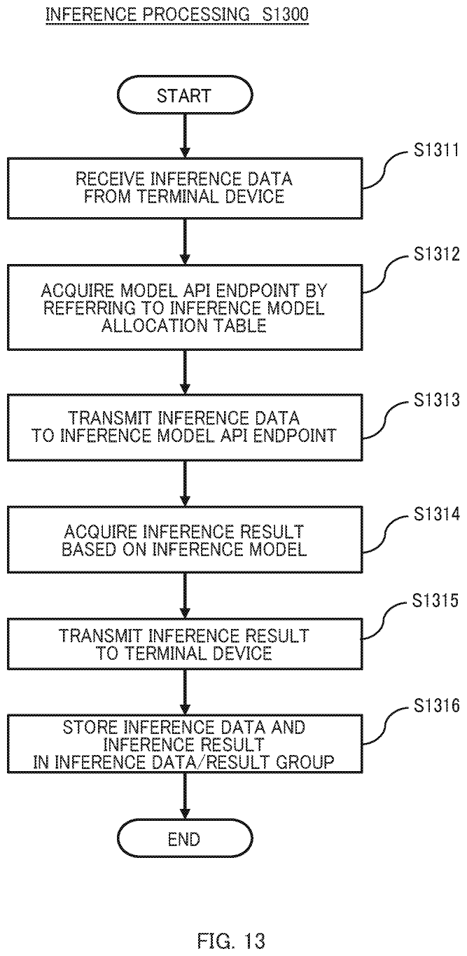

FIG. 13 is a flowchart illustrating a processing executed by the inference unit 520 of the inference server 500 (hereinafter, referred to as “inference processing S1300”). The inference processing S1300 is initiated, for example, when the inference server 500 receives inference data from the terminal device 4. However, the method is not limited thereto, and may be initiated on the basis of other methods. The inference processing S1300 will now be described with reference to FIG. 13.

When the inference data is received from the terminal device 4 along with the inference request (S1311), the inference unit 520 acquires the inference model ID and the inference model API endpoint 5123 corresponding to the terminal device ID of the terminal device 4 from the inference model allocation table 5120 (S1312). Note that, although it is assumed that the terminal device ID is contained, for example, in the inference data transmitted from the terminal device 4, the terminal device ID is not limited thereto, and may be specified on the basis of other methods.

Subsequently, the inference unit 520 transmits inference data to the acquired API endpoint and requests the API to perform inference (S1313). Note that the method of performing the inference request is not necessarily limited. If a plurality of inference model API endpoints 5123 are acquired in S1312, the inference unit 520 inputs the inference data to all the acquired endpoints.

Subsequently, the inference unit 520 acquires a result of the inference of the API by inputting the inference data to the inference model (S1314). Note that, as a method of returning the inference result from the inference model to the inference unit 520, the inference model may return the inference result to the inference unit 520 in a synchronous manner as a response to an API of the model called by the inference unit 520, or in a asynchronous manner separately from the API call.

Subsequently, the inference unit 520 returns the inference result to the terminal device 4 (S1315). Note that, if a plurality of inference model API endpoints 5123 are acquired in S1312, the inference unit 520 returns, for example, a plurality of inference results received from each of the plurality of inference models to the terminal device 4. In addition, the inference unit 520 may integrate a plurality of inference results and return the integrated one to the terminal device 4. Such a case may include, for example, a case where the inference unit 520 acquires a score indicating a likelihood of the inference for each result along with the inference result and return the inference result having the highest score among the acquired inference results to the terminal device 4, a case where, among a lot of the acquired inference results, the one having the same result as the other inference result is returned (majority decision), or the like. The inference result may be returned to the terminal device 4 in a synchronous manner as a response to the inference data received by the inference unit 520 from the terminal device 4, or may be returned in an asynchronous manner separately from the API call.

Subsequently, the inference unit 520 stores the inference data received from the terminal device 4 in S1311 and the inference result acquired from the inference model in S1315 in the inference data/result group 7150 of the management server 700 (S1316). The storage method described above includes a method, in which the management server 700 provides the API for storing the inference data or the inference result in the inference data/result group 7150, and the inference unit 520 calls the API, a method in which the inference data/result group 7150 is shared by the inference server 500 and the management server 700 via a file sharing protocol, or the like, and the inference unit 520 writes the inference data and the inference result as a file, and the like. However, the storage method is not limited thereto, and any other method may also be employed. Thus, the inference processing S1300 is terminated.

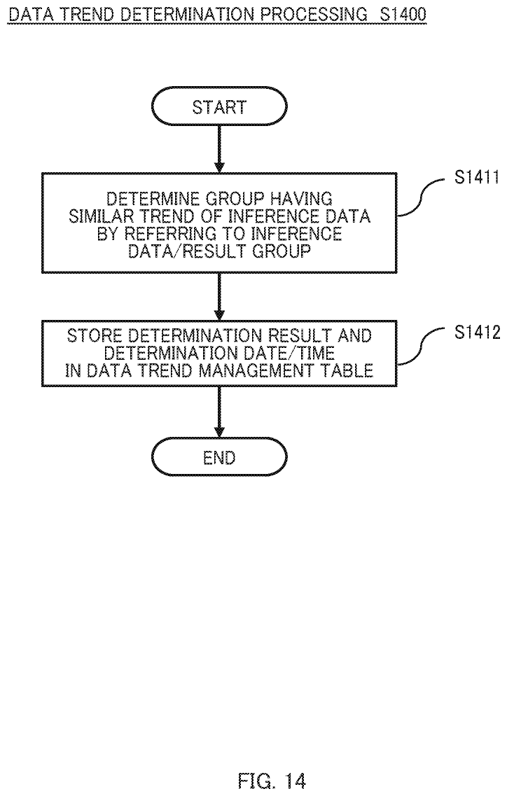

FIG. 14 is a flowchart illustrating a processing performed by the data trend determination unit 720 (hereinafter, referred to as “data trend determination processing S1400”). The data trend determination unit 720 determines a trend of the inference data transmitted from the terminal device 4 to the inference server 500 by executing the data trend determination processing S1400. The data trend determination processing S1400 is initiated, for example, when the inference unit 520 stores the inference request and the inference data in the inference data/result group 7150. However, how to initiate the data trend determination processing S1400 is not limited to thereto, and any other method may be employed. For example, the data trend determination processing S1400 may be initiated on a regular basis at every predetermined time interval. The data trend determination processing S1400 will now be described with reference to FIG. 14.

First, the data trend determination unit 720 determines a group having a similar trend for the inference data stored in the inference data/result group 7150 (for example, newly stored inference data) (S1411). As a determination method, for example, a group having a similar trend may be determined by clustering the inference data in a multidimensional space centered on a data item of the inference data. However, the determination method is not limited thereto, and any other method may also be employed for the determination.

Subsequently, the data trend determination unit 720 stores the determination result and the determination date/time in the data trend management table 7110 (S1412). Thus, the data trend determination processing S1400 is terminated.

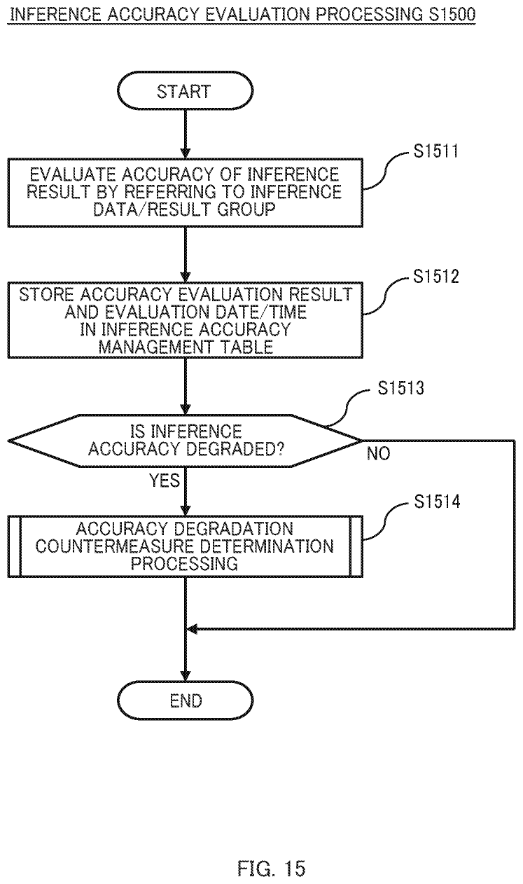

FIG. 15 is a flowchart illustrating a processing executed by the inference accuracy evaluation unit 730 (hereinafter, referred to as “inference accuracy evaluation processing S1500”). The inference accuracy evaluation unit 730 evaluates the inference accuracy for the inference executed by the inference model by executing the inference accuracy evaluation processing S1500. The inference accuracy evaluation processing S1500 is initiated, for example, when the inference unit 520 stores the inference result in the inference data/result group 7150. However, the initiation method is not limited thereto, and any other method may also be employed for initiation. For example, the inference accuracy evaluation processing S1500 may be initiated on a regular basis at every predetermined time interval. The inference accuracy evaluation processing S1500 will now be described with reference to FIG. 15.

First, the inference accuracy evaluation unit 730 evaluates the inference accuracy of the inference result of the inference data/result group 7150 (S1511). The method of evaluating the inference accuracy includes, for example, a method in which a person views and evaluates the inference result and obtains the result using a user interface, a method of comparing a predicted value obtained as the inference result with an actually measured value, or the like. However, any other method may also be employed for evaluation.

Subsequently, the inference accuracy evaluation unit 730 stores the inference accuracy evaluation result and the evaluation date/time in the inference accuracy management table 7120 (S1512).

Subsequently, the inference accuracy evaluation unit 730 determines whether or not the inference accuracy of the inference model that outputs the inference result of the evaluation target degrades (S1513). The determination method described above includes, for example, a method of comparing a predetermined threshold value with the inference accuracy and determining that the inference accuracy degrades if the inference accuracy is lower than the threshold value, or a method of determining that the inference accuracy degrades when the degradation amount from the previous inference accuracy is larger than a predetermined threshold value, or the like. However, any other method may also be employed for determination. If the inference accuracy evaluation unit 730 determines that the inference accuracy degrades (S1513: YES), the process advances to S1514. Otherwise, if the inference accuracy evaluation unit 730 does not determine that the inference accuracy degrades (S1513: NO), the inference accuracy evaluation process S1511 is terminated.

In S1514, the inference accuracy evaluation unit 730 calls the accuracy degradation countermeasure determination processing S1600 of the deployment determination unit 760. Details of the accuracy degradation countermeasure determination processing S1600 will be described below. After the accuracy degradation countermeasure determination processing S1600 is executed, the inference accuracy evaluation processing S1511 is terminated.

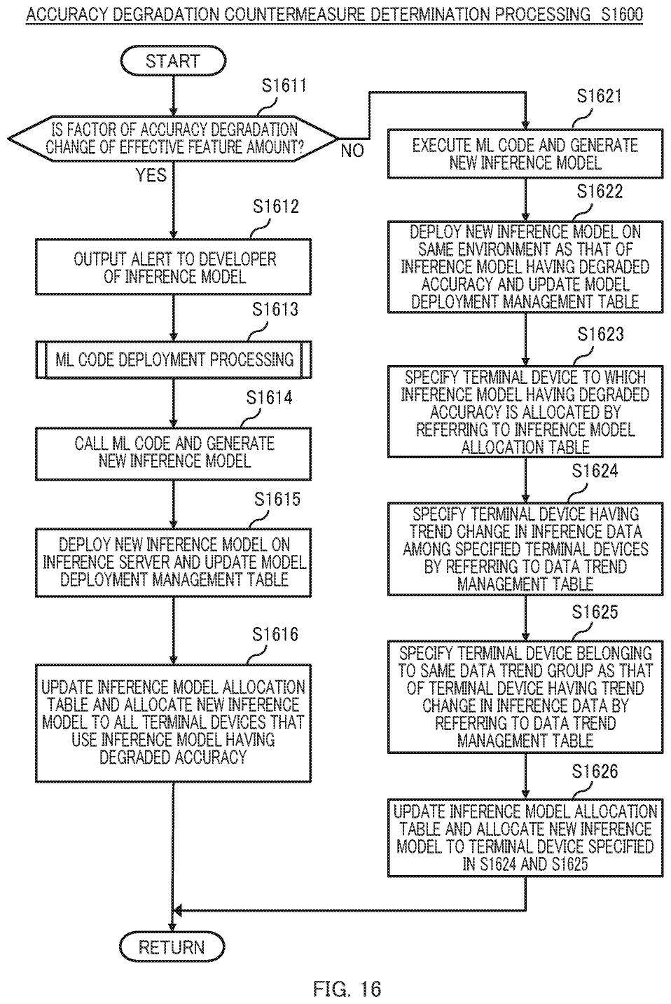

FIG. 16 is a flowchart illustrating a processing executed by the factor determination unit 750 and the deployment determination unit 760 (hereinafter, referred to as “accuracy degradation countermeasure determination processing S1600”). The accuracy degradation countermeasure determination processing S1600 is initiated when there is a call from the inference accuracy evaluation unit 730. However, the method is not limited thereto, and any other method may also be employed for initiation. For example, a developer of the inference model, an operation manager of the information processing system 100, or the like may execute the processing using a user interface. The accuracy degradation countermeasure determination processing S1600 will now be described with reference to FIG. 16.

First, the factor determination unit 750 determines whether or not a change of the effective feature amount is a factor of degradation of the inference accuracy (S1611). The determination method described above is not necessarily limited. For example, there is a method disclosed in “A Unified Approach to Interpreting Model Predictions”, S. Lundberg et al., Neural Information Processing Systems (NIPS), 2017. If the factor determination unit 750 determines that a change of the effective feature amount is the factor of degradation of the inference accuracy (S1612: YES), the process advances to 51613. Otherwise, if the factor determination unit 750 does not determine that a change of the effective feature amount is the factor of degrading the inference accuracy (S1612: NO), the process advances to S1621.

In S1612, the deployment determination unit 760 notifies (by outputting an alert) a person such as a developer of the inference model that a change of the effective feature amount causes degradation of the inference accuracy of the inference model to prompt updating of the ML code. Note that, when the training server 600 can execute the ML code under various conditions (conditions corresponding to selection of the algorithm or selection of the parameter) and can execute the software for selecting the inference model having the highest evaluation, the deployment determination unit 760 may execute the software at this timing.

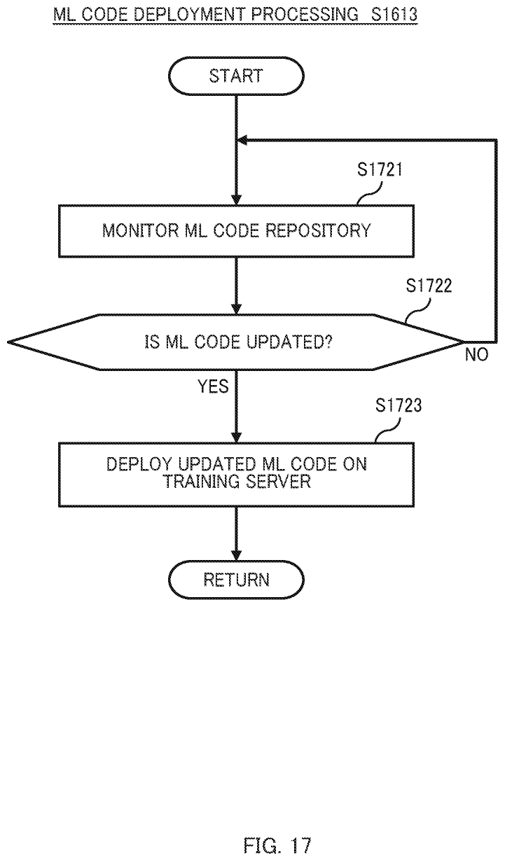

Subsequently, the deployment determination unit 760 executes the ML code deployment processing S1613 of the ML code deployment unit 7260 to deploy the ML code on the training server (S1613). The ML code deployment processing S1613 will be described below with reference to FIG. 17.

Subsequently, the deployment determination unit 760 executes the ML code deployed by the ML code deployment processing S1613 to generate a new inference model depending on the change of the effective feature amount (S1614). The deployment determination unit 760 stores the new inference model in the inference model group 7170.

Subsequently, the deployment determination unit 760 deploys the new inference model generated in S1615 on the inference server 500 of the inference environment 2a and the inference server 500 of the inference environment 2b, and stores the inference server ID of the inference server, the inference model ID of the model, and the inference model API endpoint in the inference model deployment management table 7140 (S1615).

Subsequently, the deployment determination unit 760 updates the inference model allocation table 5120 and allocates the model generated in S1615 to all of the terminal devices 4 that use the inference model having the degraded inference accuracy (S1616). That is, the deployment determination unit 760 compares the inference model ID of the inference model having the degraded inference accuracy with the inference model ID of the inference model ID 5122 of the inference model allocation table 5120, and, for the records in which both the inference model IDs match, the inference model ID of the model generated in S1615 and the inference model API endpoint of the model generated in S1615 are stored in the inference model ID 5122 and the inference model API endpoint 5123, respectively. After this processing is executed, the accuracy degradation countermeasure determination processing S1600 is terminated, and the inference accuracy evaluation processing S1500 of FIG. 15 is also terminated.

In S1621, the deployment determination unit 760 executes the ML code to generate a new inference model. The deployment determination unit 760 stores the generated new inference model in the inference model group 7170.

In S1622, the deployment determination unit 760 deploys the new inference model generated in S1621 on the inference server 500 of the inference environment 2 on which the inference model having the degraded inference accuracy is deployed, and stores the inference server ID of the inference server 500, the inference model ID of the inference model, and the inference model API endpoint in the inference model deployment management table 7140. In this case, the inference model ID and the inference model API endpoint may be overwritten, or a record may be added without overwriting. In the case of overwriting, for example, inference is performed using the inference model generated in S1621 instead of the inference model having the degraded inference accuracy. In addition, when a record is added, inference is performed by an ensemble algorithm that uses both the inference model having the degraded inference accuracy and the new inference model.

Subsequently, the deployment determination unit 760 refers to the inference model allocation table 5120 and specifies the terminal device 4 to which the inference model having the degraded inference accuracy is allocated (S1623). That is, the deployment determination unit 760 compares the inference model ID of the inference model having the degraded accuracy with the inference model ID of the inference model ID 5122 of the inference model allocation table 5120, and specifies the terminal device ID of the record in which both the inference model IDs match.

Subsequently, the deployment determination unit 760 refers to the data trend management table 7110 and specifies the terminal device 4 having a change of the trend of the transmitted inference data among the terminal devices 4 specified in S1623 (S1624). That is, the deployment determination unit 760 compares the terminal device ID specified in S1623 with the terminal device ID of the terminal device ID 7111 of the data trend management table 7110. In addition, for the records in which both the terminal device IDs match, the deployment determination unit 760 determines whether or not the data trend group ID of the data trend group ID 7112 changes during a predetermined period, and specifies the terminal device 4 of the terminal device ID of the record for which the data trend group ID changes as a terminal device 4 having a change of the trend of the inference data.

Subsequently, the deployment determination unit 760 refers to the data trend management table 7110, and specifies a terminal device 4 belonging to the same data trend group as that of the terminal device 4 having a trend change in the inference data (S1625). That is, the deployment determination unit 760 compares the terminal device ID of the terminal device 4 specified in S1624 with the terminal device ID of the terminal device ID 7111 of the data trend management table 7110, acquires a data trend group ID of a record in which both the terminal device IDs match, specifies another record having the same data trend group ID as this data trend group ID, and specifies a terminal device 4 of the terminal device ID of the specified record as a terminal device 4 belonging to the same data trend group having a trend change in the inference data.

Subsequently, the deployment determination unit 760 updates the inference model allocation table 5120 and allocates the new inference model generated in S1621 to the terminal device 4 specified in S1624 and S1625 (S1626). That is, the deployment determination unit 760 compares the terminal device ID of the terminal device 4 specified in S1624 and S1625 with the terminal device ID of the terminal device ID 5121 of the inference model allocation table 5120, and, for a record in which both the terminal device IDs match, the inference model ID of the new inference model generated in S1621 and the inference model API endpoint of the new inference model generated in S1621 are stored in the inference model ID 5122 and the inference model API endpoint 5123, respectively. Note that the inference model allocation table 5120 is updated, for example, by providing a processing step for determining whether or not the data trend changes in the middle of the data trend determination processing S1400 and performing the processing step if it is determined that the data trend changes. After this processing is executed, the accuracy degradation countermeasure determination processing S1600 is terminated, and the inference accuracy evaluation processing S1500 in FIG. 15 is also terminated.

FIG. 17 is a flowchart illustrating the ML code deployment processing S1613 described above. The ML code deployment unit 740 deploys the ML code on the training server 600 on the basis of the procedure illustrated in FIG. 17. In this example, the ML code deployment processing S1613 is initiated in response to a call from the deployment determination unit 760. However, any other method may also be employed for initiation without limiting thereto. For example, a person such as a developer of the inference model or an operation manager may execute this processing using a user interface of the ML code deployment unit 740.

In S1721, the ML code deployment unit 740 monitors the ML code group 7160. Subsequently, the ML code deployment unit 740 determines whether or not the ML code is updated in the ML code group (whether or not the ML code is updated to the content corresponding to the change of the effective feature amount) (S1722). Note the ML code update includes adding a new ML code, deleting an existing ML code, changing an existing ML code, and the like. If the ML code deployment unit 740 determines that the ML code is updated (S1722: YES), the process advances to S1723. If the ML code deployment unit 740 determines that the ML code is not updated (S1722: NO), the process advances to S1721. In this case, in order to prevent the training server 600 from being overloaded by this processing, a predetermined processing performed by the training server 600 may be stopped for a predetermined time.

In S1723, the ML code deployment unit 740 deploys the updated ML code on the training server 600. Then, the ML code deployment processing S1614 is terminated, and the process advances to S1614 of FIG. 16.

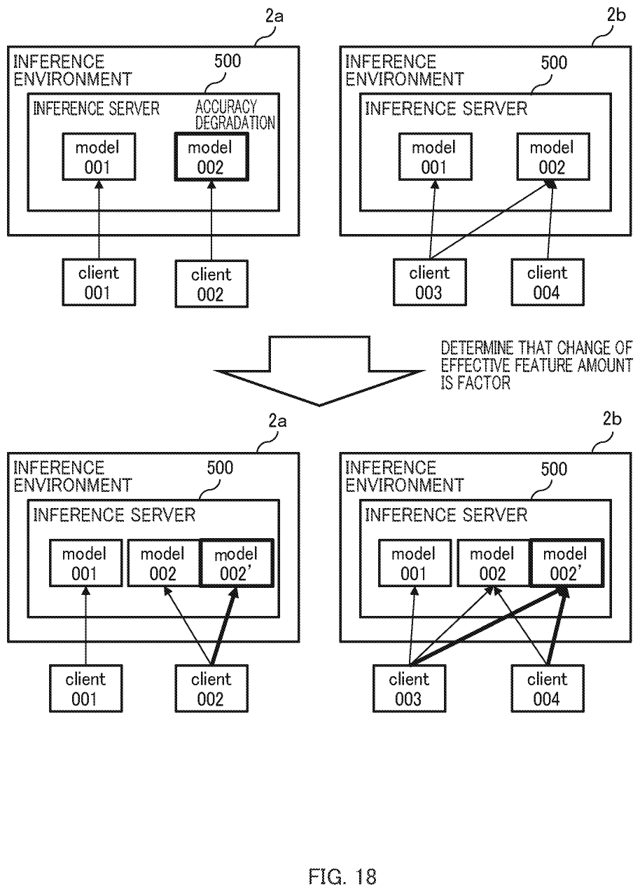

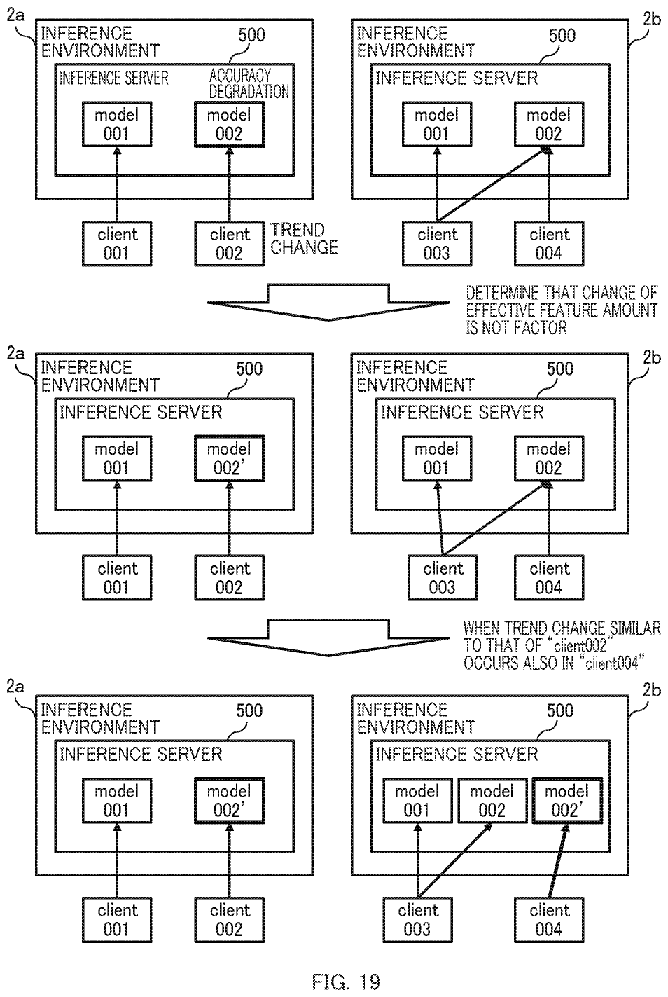

FIGS. 18 and 19 are diagrams schematically illustrating an example of the accuracy degradation countermeasure determination processing S1600 of FIG. 16

FIG. 18 shows a case where the inference accuracy of the inference model having an inference model ID of “model002” is degraded, and as a result, it is determined that the change of the effective feature amount in S1611 of FIG. 16 is a factor that causes degradation of the inference accuracy. In this example, in S1621 of FIG. 16, a new inference model having an inference model ID of “model002′” corresponding to the change of the effective feature amount is generated, and the generated new inference model is deployed on the inference server 500 of the inference environment 2a and the inference server 500 of the inference environment 2b. In addition, “model002′” is allocated to the clients “client002”, “client003”, and “client004”, to which the “model002” having the degraded inference accuracy is allocated.

FIG. 19 shows that, as a result of the change of the trend of the inference data transmitted from the terminal device 4 having a terminal device ID “client002”, the inference accuracy of the inference model having an inference model ID “model002” degrades, and as a result, it is determined in S1611 of FIG. 16 that the change of the effective feature amount is not a factor of degradation of the inference accuracy. In this example, in S1614 of FIG. 16, a new inference model having an inference model ID of “model002′” is generated, and the generated new inference model is deployed on the inference server 500 of the inference environment 2a. In addition, as the inference model ID, “model002′” instead of “model002” is allocated to “client002”. Here, in the example of FIG. 19, because the inference accuracy is degraded due to a factor limited to the terminal device 4 such as a trend change of the inference data transmitted from the terminal device 4 having a terminal device ID of “client002”, the new inference model is allocated only to this terminal device (as shown in the lower left diagram in the FIG. 19). In addition, when the same trend change as that of the inference data transmitted from the terminal device 4 having a terminal ID “client002” occurs in the inference data transmitted from the terminal device 4 having a terminal device ID of “client004”, the inference model having an inference model ID of “model002′” instead of the inference model having an inference model ID of “model002” is allocated to “client004” (as shown in the lower right diagram in FIG. 19).

As described above in details, when the information processing system 100 according to this embodiment detects that the inference accuracy of the inference model degrades, a factor of the degradation of the inference accuracy of the inference model is determined. If the change of the effective feature amount is the factor of the degradation of the inference accuracy of the inference model, for example, a new inference model corresponding to the change of the effective feature amount is generated using the ML code updated by a developer of the inference model, or the like, and the generated new inference model is deployed on each inference server 500 of the inference environment 2. Otherwise, if the change of the effective feature amount is not the factor of the degradation of the accuracy of the inference model, the information processing system 100 generates a new inference model corresponding to the inference data having the degraded inference accuracy, and the new inference model is deployed on the inference server 500 having the same inference environment as that of the inference model having the degraded inference accuracy. In addition, the information processing system 100 allocates the new inference model to the terminal device 4 to which the inference model having the degraded inference accuracy is allocated and to the terminal device 4 belonging to the same data trend group as that of the terminal device 4. In this manner, the information processing system 100 according to this embodiment appropriately determines the application method of the new inference model depending on the factor of the accuracy degradation of the inference model. Therefore, it is possible to improve the inference accuracy in each of a plurality of inference environments without degrading the inference accuracy or wastefully increasing the load or time taken for inference.

While the embodiments of the present invention have been described hereinbefore, the present invention is not limited to the embodiments described above and encompasses various modifications. In addition, for example, the configurations have been described in details in the embodiments for easy understanding, and are not necessarily limited to a case comprising all the configurations described above. Furthermore, a part of the configurations of each embodiment may be added, deleted, or substituted with other configurations.

Each of the aforementioned configurations, functions, processing units, processing means, and the like may be realized by hardware by designing a part or all of them, for example, using an integrated circuit. In addition, they may be realized by a program code of the software that realizes each function of the embodiments. In this case, a storage medium recording the program code is provided to the information processing apparatus (computer), and a processor included in the information processing apparatus reads the program code stored in the storage medium. In this case, the program code itself read from the storage medium realizes the functions of the aforementioned embodiments, and the program code itself and the storage medium storing the program code constitute the present invention. The storage medium for supplying such a program code may include, for example, a hard disk, SSD (Solid State Drive), optical disk, magneto-optical disk, CD-R, flexible disk, CD-ROM, DVD-ROM, magnetic tape, a non-volatile memory card, ROM or the like.

In the embodiments described above, the control lines and information lines indicate what is considered necessary for the explanation, and not all the control lines and information lines on the product are necessarily illustrated. All configurations may be connected to each other. In addition, although various types of information are shown in a table format in the aforementioned description, such information may be managed in any format other than the table.

What is claimed is:

1. An information processing system comprising:
a plurality of inference units that perform inference by inputting data to one or more inference models;
an inference accuracy evaluation unit that evaluates inference accuracy of the inference units;
a training unit that generates a new inference model by training data input to a first inference unit when degradation of the inference accuracy is detected in the first inference unit;
a factor determination unit that determines a factor of the degradation of the inference accuracy; and
a deployment determination unit that determines whether or not the new inference model is applied to a second inference unit other than the first inference unit on the basis of the determined factor.

2. The information processing system according to claim 1, wherein the deployment determination unit determines one or more inference units including the first inference unit among the plurality of inference units as an application target of the new inference model if the factor determination unit determines that a change of an effective feature amount of the inference model is the factor.

3. The information processing system according to claim 2, wherein the deployment determination unit determines all of the inference units that use the new inference unit as an application target of the new inference model if the factor determination unit determines that a change of the effective feature amount of the inference model is the factor.

4. The information processing system according to claim 1, further comprising a trend determination unit that specifies the second inference unit to which data having a trend change similar to that of the data input to the first inference unit is input if the factor determination unit determines that the trend change of the data input to the first inference unit is the factor,
wherein the deployment determination unit determines the first inference unit and the second inference unit specified by the trend determination unit as application targets of the new inference model.

5. The information processing system according to claim 4, wherein the trend determination unit continuously monitors whether or not a trend change similar to the trend change occurs in data input to the other second inference unit not determined as the application target of the new inference model, and
the deployment determination unit determines the other second inference unit as the application target of the new inference model if occurrence of a trend change similar to the trend change is detected in the data input to the other second inference unit.

6. The information processing system according to claim 1, wherein the inference unit performs inference by allocating the input data to one or more of the plurality of inference models.

7. The information processing system according to claim 6, wherein the inference unit performs inference by allocating the input data to the plurality of inference models and executing an ensemble algorithm.

8. The information processing system according to claim 1, wherein the information processing system is communicatably connected to a plurality of terminal devices,
the inference unit performs inference by inputting the data acquired from the terminal device to the inference model,
the deployment determination unit manages a relationship between each of the terminal devices and the inference model serving as an input destination of the data acquired from each terminal device, and
the relationship is managed such that the generated new inference model becomes an input destination of the data acquired from the terminal device serving as an acquisition source of the data input to the first inference unit when degradation of inference accuracy is detected in any one of the first inference units.

9. A method for controlling an information processing system having a plurality of inference units that perform inference by inputting data to one or more inference models, the information processing system executing steps of:
performing inference using a plurality of inference units that perform inference by inputting data to one or more inference models;
evaluating inference accuracy of the inference units;
generating a new inference model by training data input to a first inference unit when degradation of the inference accuracy is detected in the first inference unit;
determining a factor of the degradation of the inference accuracy; and
determining whether or not the new inference model is applied to a second inference unit other than the first inference unit on the basis of the determined factor.

10. The method for controlling the information processing system according to claim 9, wherein the information processing system further executes determining one or more inference units including the first inference unit among the plurality of inference units as an application target of the new inference model if a change of an effective feature amount of the inference model is determined as the factor.

11. The method for controlling the information processing system according to claim 10, wherein the information processing system further executes determining all of the inference units that use the new inference unit as an application target of the new inference model if a change of the effective feature amount of the inference model is determined as the factor.

12. The method for controlling the information processing system according to claim 9, wherein the information processing system further executes:
specifying the second inference unit to which data having a trend change similar to that of the data input to the first inference unit is input if the trend change of the data input to the first inference unit is determined as the factor; and
determining the first inference unit and the specified second inference unit as an application target of the new inference model.

13. The method for controlling the information processing system according to claim 12, wherein the information processing system further executes:
continuously monitoring whether or not a trend change similar to the trend change occurs in data input to the other second inference unit not determined as the application target of the new inference model; and
determining the other second inference unit as the application target of the new inference model if occurrence of a trend change similar to the trend change is detected in the data input to the other second inference unit.

14. The method for controlling the information processing system according to claim 9, wherein the inference unit performs inference by allocating the input data to one or more of the plurality of inference models.

15. The method for controlling the information processing system according to claim 14, wherein the inference unit performs inference by allocating the input data to the plurality of inference models and executing an ensemble algorithm.
